(19) United States
(12) Patent Application Publication
(10) Pub. No.: US 2021/0016714 A1
(43) Pub. Date: Jan. 21, 2021

(54) Running Board

(71) Applicant: Yonghui Guo, Taiyuan (CN)

(72) Inventor: Yonghui Guo, Taiyuan (CN)

(73) Assignee: Fu Guo, Vancouver (CA)

(21) Appl. No.: 16/511,814

(22) Filed: Jul. 15, 2019

(51) Int. Cl. B60R 3/00; B60R 13/00

(52) U.S. Cl. CPC B60R 3/002; B60R 13/005

(57) ABSTRACT

A running board design is provided for automotive vehicles. Two metal end caps and two metal square tubes are connected together, creating a frame with seamless peripheral surface for the running board. A metal stepping plate is on the top of the frame to provide stepping area. A plurality of metal clamping sliders move in two grooves on the bottom of the stepping plate, which clamp and fix the stepping plate onto the frame. At the same time the clamping sliders provide a platform where mounting brackets can be installed. The clamping sliders allow the running board to be adjusted to a position which provides the best cab access. Extra clamping sliders can be added with ease for extra-long vehicles. The running board is fully made of metal, leading to increased strength and durability, as well as improved appearance.

### FIELD

The present disclosure relates to a running board for attachment to a vehicle.

### BACKGROUND

Running boards are popular aftermarket upgrade for vehicles to provide convenience of entering and exiting the vehicles. In the current market, there are various running board products, while most of them are made of plastic, either entirely or partially. Making parts like the main body, stepping pads, and end caps out of plastic results in compromised quality and easy breakdown.

### SUMMARY

According to one aspect of the present invention, two identical metal end caps and two identical metal square tubes are connected together, creating a frame with seamless peripheral surface for the running board. A metal stepping plate sits on the top of the frame to provide stepping area. A plurality of metal clamping sliders move in two grooves on the bottom of the stepping plate, which clamp and fix the stepping plate onto the frame. At the same time the clamping sliders provide a platform where mounting brackets can be installed. The clamping sliders allow the running board to be adjusted to a position which provides the best cab access. Adding extra clamping sliders for extra support is easy.

### BRIEF DESCRIPTION OF THE DRAWINGS

The invention will be readily appreciated as the same becomes better understood by reference to the following detailed description when considered in connection with the accompanying drawings wherein:

FIG. 1 is a break perspective view illustrating the bottom side of a running board according to the invention;

FIG. 2 is a perspective view illustrating the top side of the running board in FIG. 1;

FIG. 3 is a perspective view illustrating the frame of the running board in FIG. 1;

FIG. 4 is a section view illustrating part of the cross-sectional area of the running board in FIG. 1;

FIG. 5 is a perspective view of a clamping slider of the running board in FIG. 1;

FIG. 6 is a perspective view of a L-shaped clamping bar of the running board in FIG. 1.

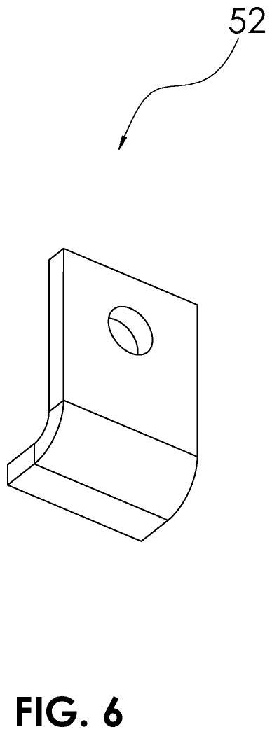

### DETAILED DESCRIPTION

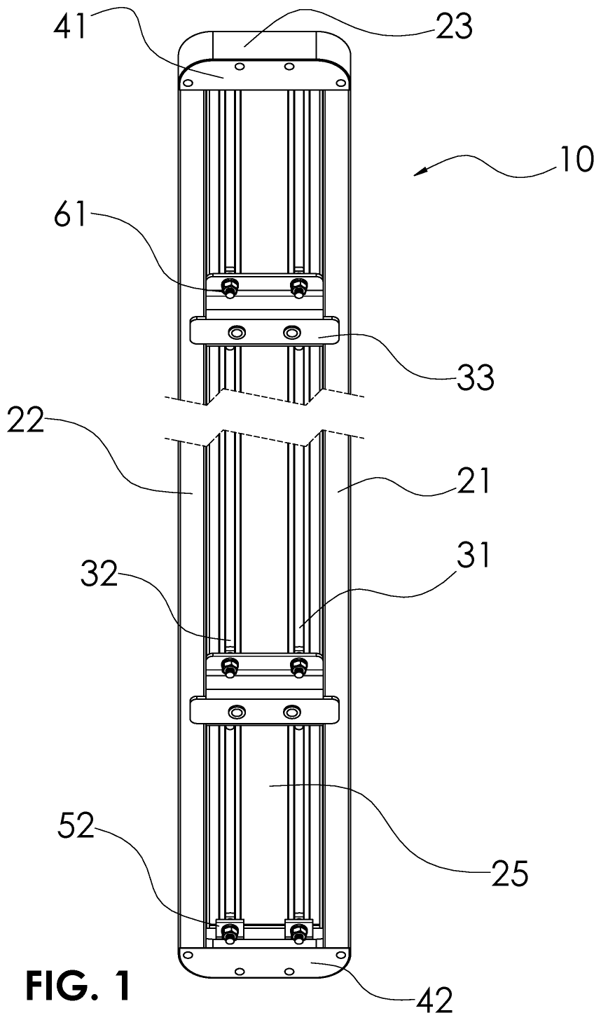

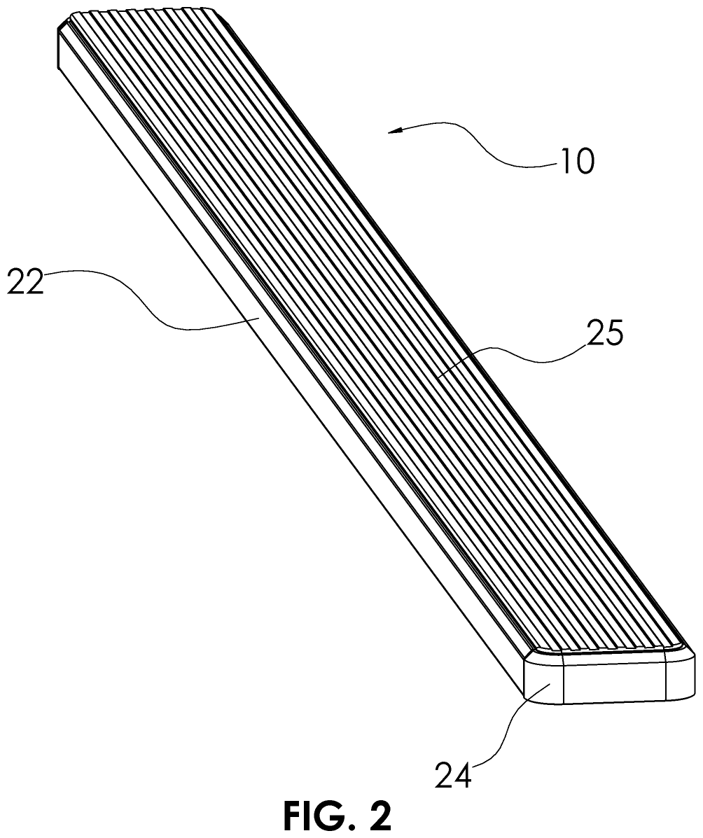

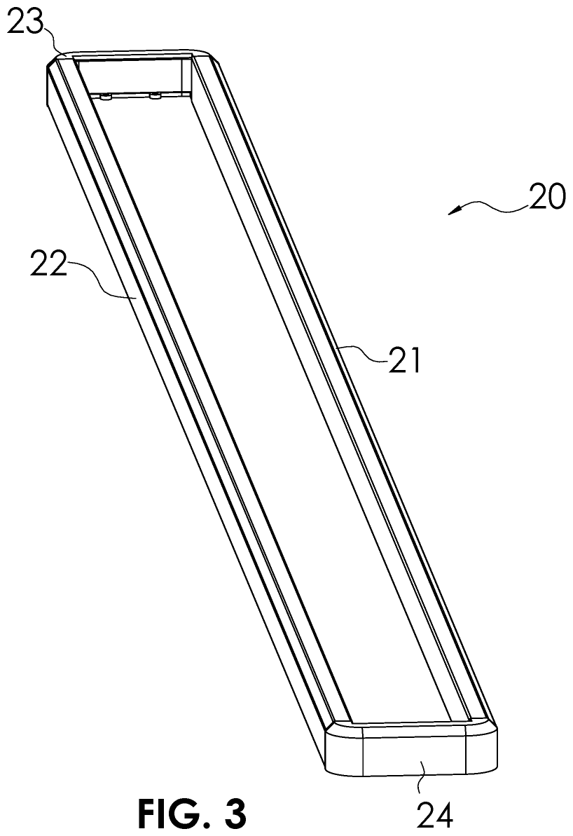

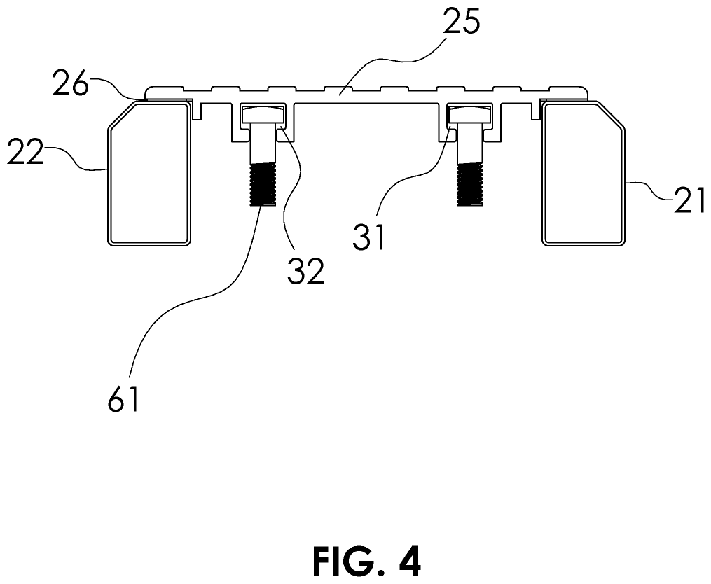

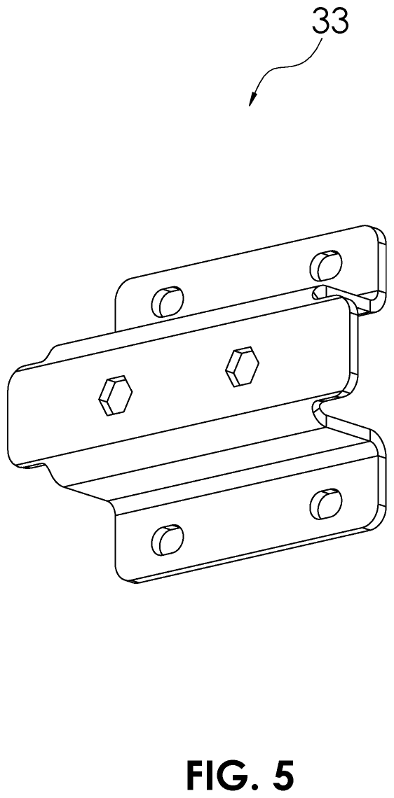

FIG. 1-5 illustrate one exemplary running board 10 in accordance with the present disclosure. Two identical metal square tubes 21 and 22 are parallel to each other. Two identical metal end caps 23 and 24 are located on each end of the parallel square tubes 21 and 22, creating a metal frame 20 with a seamless peripheral surface. The end caps 23 and 24 are manufactured by stamping, consequently with nice appearance and low cost. A metal stepping plate 25 is positioned on the top of the frame 20 to offer a full stepping area for entering or exiting the vehicle. A non-slippery tread is part of the stepping plate 25, this design saves manufacturing resources and time compared to running boards with add-on non-slippery pads. This full metal body guarantees a rigid structure with durability. A rubber cushion 26 covers the contacting surface between the stepping plate 35 and the frame 20, helping strengthen and seal the running board as well as absorb shocks. There are two T-shaped sliding grooves 31 and 32 on the bottom of the stepping plate 25, providing mounting space for a plurality of T-shaped bolts 61. A plurality of clamping sliders 33 help fix the stepping plate 25 on the frame 20 thanks to the locking mechanism of the T-shaped sliding grooves 31 and 32, and the T-shaped bolts 61. A plurality of L-shaped clamping bars 52 are used to secure the ends of stepping plate 25 on the frame 20.

The clamping sliders 33 also provide mounting platform for brackets to install the running board 10 on the vehicle. The brackets are not part of the present invention. The clamping sliders 33 allow the running board 10 to be adjusted to a position which provides the best cab access, at the same time make the running board 10 fit multiple vehicle models without changing any parts, leading to high production efficiency and low inventory risk. Besides, extra clamping sliders can be added with ease for extra support with respect to extra-long vehicles. Depending on the vehicle model, the number of clamping sliders, which is same to that of supporting brackets, that one vehicle needs varies from 2 to 4. Two logo plates 41 and 42, where product info and brand name can be printed or cut on, are riveted on the end cap 23 and 24. The way the logo plate 42 is manufactured and installed makes sophisticated processing of the plate possible at reasonable cost, and also provides an integrated presentation.

The above-described embodiments of the invention are intended to be examples of the present invention, many alterations and modifications may be effected thereto, by those of skills in the art, without departing from the scope of the invention which is defined by the claims appended hereto.

What is claimed is:

1. A running board for automotive vehicles, said running board has two metal square tubes and two metal end caps, creating a metal frame with seamless peripheral surface;

2. A metal stepping plate sits on the top of said frame, offering a stepping area for entering or exiting the vehicle and a rigid structure with durability; a non-slippery tread is part of said stepping plate.

3. Said stepping plate is installed on said frame via two sliding grooves, a plurality of L-shaped clamping bars, clamping sliders and T-shaped bolts. Said clamping sliders allow said running board to be adjusted to a position which provides the best cab access, making said running board fit multiple vehicle models without changing any parts, hence create high production efficiency and low inventory risk.

4. Extra clamping sliders can be added with ease for extra support with respect to extra-long vehicles.

5. A rubber cushion covers the contacting surface between said stepping plate and said frame, helping strengthen and seal said running board, and absorb shocks.

6. Said end caps are manufactured by stamping, consequently with nice appearance and low cost.

7. Said L-shaped clamping bars secure the ends of said stepping plate on said frame, a metal logo plate is riveted on the bottom of each said end cap.
